(19) United States
(12) Patent Application Publication
(10) Pub. No.: US 2026/0359107 A1
(43) Pub. Date: Nov. 12, 2026

(54) METHOD FOR MANAGING SHARED DATA

(71) Applicant: Schaeffler Technologies AG & Co. KG, Herzogenaurach (DE)

(72) Inventors: Stéphane ELOY, Toulouse (FR); Nicolas ROMEA, ST PIERRE-DE-LAGES (FR)

(21) Appl. No.: 19/137,177

(22) PCT Filed: Jan. 30, 2024
(86) PCT No.: PCT/EP2024/052120

§ 371 Date: Jun. 9, 2025

(30) Foreign Application Priority Data
Feb. 2, 2023 (FR) FR2300953

(51) Int. Cl. G06F 9/48; G06F 9/52

(52) U.S. Cl. CPC G06F 9/4881; G06F 9/528

(57) ABSTRACT

The invention relates to a computer-implemented method for managing shared data, wherein a variable VAR is accessible by a plurality of tasks TASK_i executed in parallel. A priority variable PRIO_DATA is associated with the variable VAR. A priority constant PRIO_i characterizes the priority order of the task TASK_i. At a time t1, the task TASK_i uses the value of the shared variable VAR. If PRIO_i>PRIO_DATA then PRIO_DATA is updated to the value PRIO_i. After execution of the same task TASK_i at a time t2>t1, the task TASK_i generates a value VAR_UPDATE_i of the variable VAR. If PRIO_DATA at time t2=PRIO_i, then VAR is updated to the value VAR_UPDATE_i and PRIO_DATA is updated to an initial value. A computing device and a non-transient computer-readable storage medium are also disclosed.

### TECHNICAL FIELD

The present disclosure relates to the field of software tasks performed in parallel.

### PRIOR ART

Multi-core processors allow multiple software tasks to be executed in parallel. Execution of software tasks in parallel is for example useful in the field of embedded systems.

The response time of software tasks is an important element in ensuring correct functional behavior (for example control of a combustion engine) and safety (for example, injection cut-off must be very fast in combustion engines to ensure driver safety).

Software tasks (or functions) typically comprise one or more algorithms called runnables that are executed when the task is itself triggered by an event (e.g. event related to the position of the motor) in time-domain signals.

The same variable may be used by a plurality of runnables that are executed at different times, sometimes in parallel, and the value of the variable may change over time depending on its determined value at the end of each runnable. In certain cases, the variable may even be instantly made available to other runnables as soon as it is modified. Production of data based on this variable may then lead to concurrent access to the variable if it is read/writable by concurrent tasks (for example, concurrent tasks executed in various cores, each task having one or more runnables).

LWW problems (LWW standing for Last Writer Win) may then occur when there is an overlap between read and write access to the variable. This may lead to the value of the variable computed by one task being overwritten by another concurrent task.

### SUMMARY

The present disclosure is intended to improve the situation.

A computer-implemented method for managing data shared through a memory is provided, wherein a shared variable VAR is stored in the memory, the variable VAR being accessible by at least two tasks TASK_i (i=1 . . . n, n≥2) executed in parallel with one another, each task TASK_i comprising at least one runnable RUN_ij (j=1 . . . k, k≥1), when TASK_i comprises at least two runnables RUN_ij the latter are executed sequentially, a priority variable PRIO_DATA associated with the variable VAR being stored in the memory and initially taking a value PRIO_INI, a priority constant PRIO_i being stored in the memory for each of the tasks TASK_i, the priority constant PRIO_i characterizing the priority order of the task TASK_i, PRIO_INI being reserved for the lowest priority and being different from each of the priority constants PRIO_i, each of the runnables RUN_ij having an associated priority constant PRIO_RUN_ij characterizing the priority order of the runnable RUN_ij producing the variable VAR, for each of the tasks TASK_i, the priority constant PRIO_i of the task TASK_i being the maximum of the priority constants PRIO_RUN_ij of the runnables RUN_ij of this task, the method comprising the following steps:
at a time t1:
   initiating the i-th task TASK_i using the value of the variable VAR shared at t1 in the memory, and
   if PRIO_i>PRIO_DATA at time t1 then PRIO_DATA is updated to the value PRIO_i,
after execution of the same i-th task TASK_i at a time t2>t1, the i-th task TASK_i generates a value VAR_UPDATE_i of the variable VAR,
   if PRIO_DATA at time t2=PRIO_i, then VAR is updated to the value VAR_UPDATE_i and PRIO_DATA is updated to the value PRIO_INI.

The method for managing shared data may have one or more of the following features:
the values of each PRIO_i are strictly increasing in the priority order of the task TASK_i producing the variable VAR, PRIO_INI being smaller than each of the priority constants PRIO_i, and preferably PRIO_INI=0;
each of the tasks TASK_i is executed on a core CORE_i of its own;
the method in addition comprises a first buffer BUFF_1 arranged between the memory and a first core CORE_1 on which a first task TASK_1 is executed, and/or a second buffer BUFF_2 arranged between the memory and a second core CORE_2 on which a second task TASK_2 is executed, the first and second buffers BUFF_1, BUFF_2 comprising copies of the values of the variables VAR used by TASK_1 and TASK_2 as input and output of TASK_1 and TASK_2, the first and second buffers BUFF_1, BUFF_2 being able to interact with the memory to modify the variable VAR output from the tasks TASK_i;
the first and second buffers BUFF_1, BUFF_2 comprise copies of the values of the variables VAR input into and output from the runnables RUN_1j, RUN_2j of each of TASK_1 and TASK_2;
the priority constant PRIO_i is created offline;
the memory is a read-write memory, in particular a random-access memory (RAM).

According to another aspect, a computer program comprising instructions for implementing all or some of a method such as defined herein when this program is executed by a processor is provided. According to another aspect, a non-transitory computer-readable storage medium on which such a program is stored is provided.

According to another aspect, a computing device is provided, this computing device comprising: a memory for storing at least some of the instructions of the computer program of the preceding claim; and a processor that accesses the memory to read the aforementioned instructions and then execute the above method.

According to another aspect, a non-transient computer-readable storage medium on which a computer program for implementing the above method, when the computer program is executed by a processor, is stored, is provided.

According to another aspect, a vehicle with an embedded system comprising the above computing device is provided.

### BRIEF DESCRIPTION OF THE DRAWINGS

Other features, details and advantages will become apparent on reading the following detailed description, and on analyzing the appended drawings, in which:

FIG. 1 shows one example of a shared variable for which there is an LWW problem.

FIG. 2 shows another example of a shared variable for which there is an LWW problem.

FIG. 3 shows yet another example of a shared variable for which there is an LWW problem.

FIG. 4 shows one example of attribution of priority between multiple tasks each having one or more runnables.

FIG. 5 shows a flowchart for managing priority between multiple tasks using a shared variable.

FIG. 6 shows a first example of managing priority between two concurrent tasks using a shared variable.

FIG. 7 shows a second example of managing priority between two concurrent tasks using a shared variable.

FIG. 8 shows a third example of managing priority between two concurrent tasks using a shared variable.

FIG. 9 shows a fourth example of managing priority between two concurrent tasks using a shared variable.

FIG. 10 shows a fifth example of managing priority between two concurrent tasks using a shared variable.

FIG. 11 shows a sixth example of managing priority between two concurrent tasks using a shared variable.

FIG. 12 shows one example of managing priority between two non-concurrent tasks using a shared variable.

### DESCRIPTION OF THE EMBODIMENTS

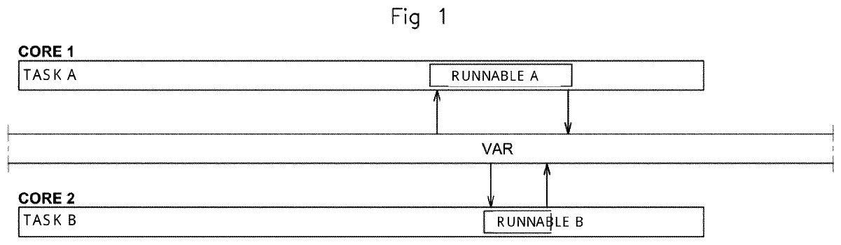

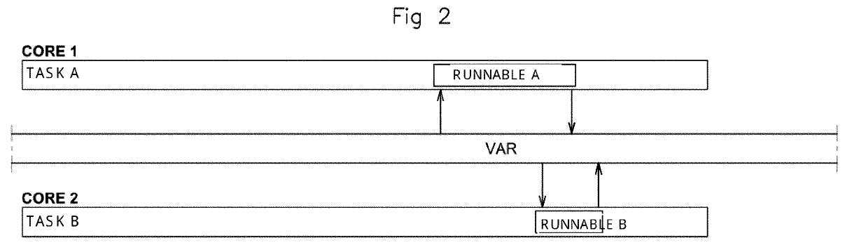

Reference will now be made to FIGS. 1 and 2, which illustrate particular cases in which LWW problems may arise (LWW being the acronym of Last Writer Win).

A core CORE 1 contains a task TASK A that contains a runnable RUNNABLE A. A core CORE 2 arranged in parallel with the core CORE 1 contains a task TASK B that contains a runnable RUNNABLE B. Each runnable RUNNABLE A, RUNNABLE B accesses a variable VAR at the beginning of execution and updates the value of the variable VAR with the value that they computed, at the end of execution. The runnables RUNNABLE A, RUNNABLE B access and update the variable VAR at different times.

Thus, in the particular case of FIG. 1, the variable VAR is accessed first by RUNNABLE A, and then by RUNNABLE B. RUNNABLE B ends before RUNNABLE A, and the value of the variable VAR is therefore updated sequentially by RUNNABLE B and then RUNNABLE A. Thus, when the tasks TASK A and TASK B have completed, the variable has the value updated by TASK A.

In the inverse case, in FIG. 2, RUNNABLE A ends before RUNNABLE B, and the value of the variable VAR is therefore updated sequentially by RUNNABLE A and then RUNNABLE B. Thus, when TASK A and TASK B have completed, the variable has the value updated by TASK B.

It may therefore be seen that the priority of TASK A and TASK B is not defined by their intrinsic priority but is determined by their order in time. There may therefore be an LWW problem with the value of the variable VAR since it will be the last runnable to update the value of the variable VAR that will determine the value of the variable VAR when the tasks TASK A and TASK B have completed.

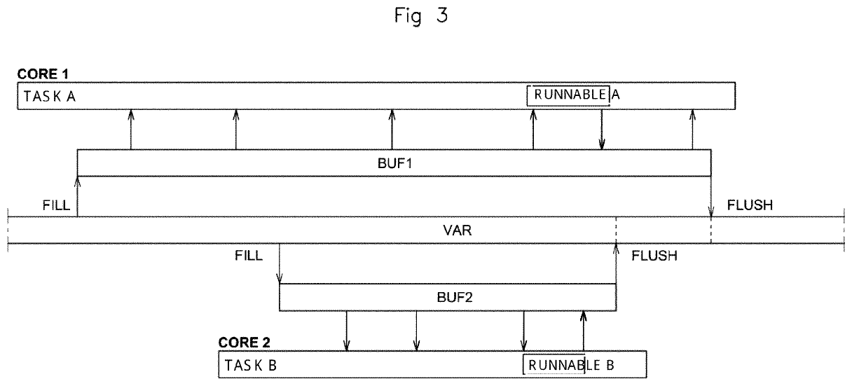

With reference to FIG. 3, the case of FIG. 1 is now illustrated with buffer memories, or buffers, BUF1, BUF2, interacting between the memory containing the variable VAR and the tasks TASK A and TASK B, respectively.

The buffers BUF1, BUF2 are used to ensure the consistency of the data accessed in simultaneous tasks (generally from various cores). A buffering mechanism is commonly used to ensure the stability of a variable read multiple times in a task and written in other concurrent tasks, and the consistency of a set of variables that are read in one task and written in other simultaneous tasks.

The buffers BUF1, BUF2 are created for each simultaneous task TASK A and TASK B. Furthermore, FILL and FLUSH routines are generated to manage access to data in the global memory, and in particular the variable VAR, and to fill and empty the (read and write) buffers. Simultaneous access by these FILL and FLUSH routines to the global memory is avoided through use of semaphores. FILL routine: under the semaphore, it copies data from the global memory to the local buffer (instruction to fill the buffer). FLUSH routine: under the semaphore, it copies the local buffer to the data of the global memory (instruction to empty the buffer).

It will be noted that the use of buffers accentuates the LWW problem with the variable VAR, because it increases the time between the read and write access by concurrent tasks to this variable. Instead of reading and writing occurring at the time of execution of the runnable, they occur when the buffer is emptied, a few moments after the end of the runnable. Thus, in the case of FIG. 3, the variable VAR updated by RUNNABLE A is not updated at the end of execution of RUNNABLE A as in the case of FIG. 1, but when the buffer BUF1 is emptied.

In response to particular situations such as these, a method for managing priority is provided. The invention consists in managing certain priorities for shared variables, optionally buffered shared variables, that could be overwritten by concurrent tasks. To avoid an LWW situation, a priority order is managed for each shared variable associated with the concurrent tasks.

The method essentially consists of 2 steps. The first step is carried out during the design of the algorithm and consists in assigning/determining the priority orders of the tasks (and of the runnables). This first step may be carried out offline or in real time. The second step is carried out dynamically, during execution of the runnables, and consists in attributing a value of the variable VAR in real time depending on the priorities of the runnables/tasks.

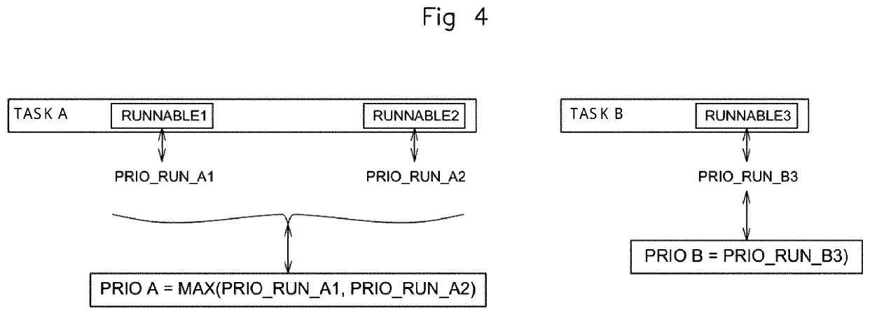

With reference now to FIG. 4, the first step corresponding to the attribution of priority orders will be described.

In a general case where n tasks TASK_i (i=1 . . . n, n≥2) are executed in parallel, each having j runnables RUN_ij (j=1 . . . k, k≥1), the shared variable VAR is stored in the memory and is accessible by the tasks TASK_i executed in parallel. According to one embodiment, each of the tasks TASK_i is executed on a core CORE_i of its own. The memory on which the variable VAR is stored is for example a read-write memory, in particular a random-access memory (RAM).

Each task TASK_i comprises at least one runnable RUN_ij. When the task TASK_i comprises two or more runnables RUN_ij these are executed sequentially. A priority constant PRIO_i is stored in the memory for each of the tasks TASK_i. The priority constant PRIO_i characterizes the priority order of the task TASK_i producing the variable VAR. A constant PRIO_INI is reserved for the lowest priority and is different from each of the priority constants PRIO_i. Each of the runnables RUN_ij has an associated priority constant PRIO_RUN_ij. The priority constant PRIO_RUN_ij characterizes the priority order of the runnable RUN_ij producing the variable VAR. For each of the tasks TASK_i, the priority constant PRIO_i of the task TASK_i is the maximum of the priority constants PRIO_RUN_ij of the runnables RUN_ij of this task.

Thus, with reference to the particular case of FIG. 4, TASK A is executed in parallel with TASK B. TASK A comprises two runnables RUNNABLE 1 and RUNNABLE 2 that execute sequentially. TASK B comprises one runnable RUNNABLE 3.

Each runnable RUNNABLE 1, RUNNABLE 2, RUNNABLE 3 has an associated priority constant PRIO_RUN_A1, PRIO_RUN_A2, PRIO_RUN_B3. In order to determine the overall priority of TASK A with respect to TASK B, the priority constant PRIO A of TASK A is the maximum of the priority constants PRIO_RUN_A1, PRIO_RUN_A2 of the runnables RUNNABLE 1, RUNNABLE 2 of this task. As regards TASK B, the priority constant PRIO B is simply the priority constant PRIO_RUN_B3 of RUNNABLE 3, since this task comprises no runnable other than RUNNABLE 3. None of the constants PRIO A, PRIO B has the value of the initiation constant PRIO_INI reserved for the lowest priority.

The priority constants are, according to one embodiment, positive and strictly increasing. According to one embodiment, PRIO_INI=0.

Thus, for subsequent management of the priority of TASK A with respect to TASK B, the constants PRIO A and PRIO B will be compared. If PRIO A>PRIO B then TASK A will have priority over TASK B as regards production of the variable VAR. However, if PRIO B>PRIO A, then TASK B will have priority over TASK A as regards production of the variable VAR.

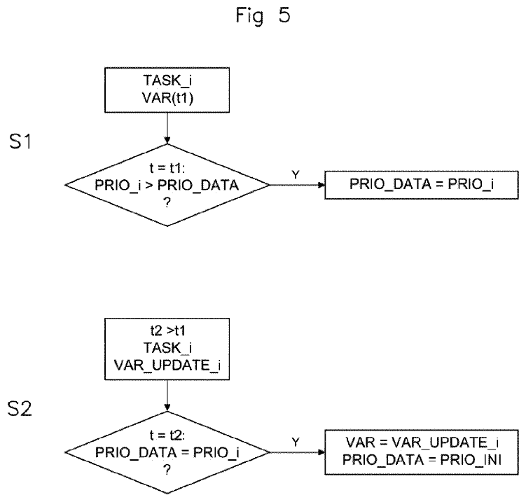

With reference now to FIG. 5, the second step corresponding to the real-time attribution of a value of the variable VAR depending on the priority orders of TASK A and TASK B will be described.

In step S1, at a time t1, the i-th task TASK_i having the priority PRIO_i is initiated using the value of the variable VAR shared at t1 in the memory (the task TASK_i reads the variable VAR), and if PRIO_i>PRIO_DATA at time t1 (i.e. the priority of the task TASK_i is higher than the priority of the task in progress at time t1, see arrow “Y” in FIG. 5) then PRIO_DATA is updated to the value PRIO_i (i.e. the new priority is the priority of the task TASK_i).

The time t1 of reading of the variable VAR may be the time of initiation of execution of the task or an earlier time, such as for example the time at which the buffer is filled (FILL routine) if a buffer is used.

In step S2, after execution of the same i-th task TASK_i at a time t2>t1, the i-th task TASK_i generates a value VAR_UPDATE_i of the variable VAR, if PRIO_DATA at time t2=PRIO_i (see arrow “Y” in FIG. 5), then VAR is updated to the value VAR_UPDATE_i and PRIO_DATA is updated to the value PRIO_INI (the variable VAR computed by the task TASK_i is written to memory).

The time t2 of writing of the variable VAR may be the time of end of execution of the task or a later time, such as for example the time at which the buffer is emptied (FLUSH routine) if a buffer is used.

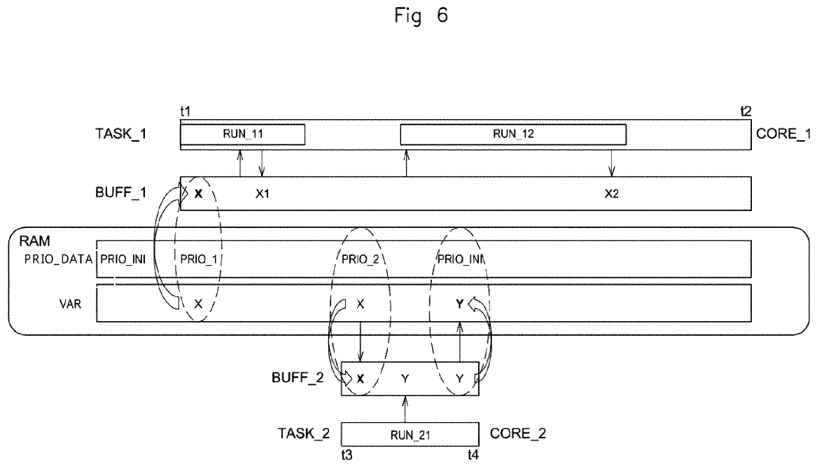

Various applicable cases of the second step will be illustrated with reference to FIGS. 6 to 12 for the case of FIG. 4 where CORE A contains a task TASK A with two runnables RUNNABLE 1, RUNNABLE 2, and CORE B parallel to CORE A contains a task TASK B with one runnable RUNNABLE 3. For the sake of consistency with numerical references used in the definition of the algorithm, in FIGS. 6 to 12, CORE A will be identified as CORE_1, TASK A as TASK_1, and the runnables of TASK_1 will be RUN_11 and RUN_12. Likewise, CORE B will be identified as CORE_2, TASK B as TASK_2, and the runnable of TASK_2 will be RUN_21.

FIGS. 6 to 12 illustrate an embodiment in which buffers BUFF_1, BUFF_2 (similar to the buffers BUF1, BUF2 of FIG. 3) are present. However, there may be only one or no buffers. The read and write times of the variable VAR correspond to the times at which the buffer in question is filled (FILL routine) and emptied (FLUSH routine) when buffers are present. If buffers are not present, the times at which the variable VAR is read and written may be the start and end times of the tasks.

In the case of FIG. 6, the priority PRIO_2 of TASK_2 is set higher than the priority PRIO_1 of TASK_1. Initially in the RAM, the variable PRIO_DATA is set to 0 (because in this particular case PRIO_INI=0). TASK_1 starts before TASK_2. When TASK_1 starts at time t1, the priority of TASK_1 is compared to the value of the variable PRIO_DATA at that time. Since PRIO_DATA=0, PRIO_1>PRIO_DATA and therefore PRIO_DATA is updated with the value PRIO_1. Step S1 described above has just been completed.

Simultaneously, the variable VAR which is equal to x at that time is copied to the buffer BUFF_1. The first runnable RUN_11 of TASK_1 is initiated with the value x of the variable VAR copied to the buffer BUFF_1 at that time. When the first runnable RUN_11 ends, it produces an updated value x1 of the variable VAR, which is copied to the buffer BUFF_1, but not to the memory because the buffer BUFF_1 has not yet been instructed to empty. When the second runnable RUN_12 of TASK_1 is initiated, it takes the value x1 of the variable VAR available in BUFF_1 at that time. When the second runnable RUN_12 ends, it produces an updated value x2 of the variable VAR, which is copied to the buffer BUFF_1. There are no other runnables in this buffer.

Priority management according to step S2 occurs when the buffer BUFF_1 is emptied, in order to determine whether the value x2 of the variable VAR may be copied to the memory in order to be used by other tasks. At time t2 (which is the time at which the buffer BUFF_1 is emptied), the priority PRIO_1 of TASK_1 is compared to PRIO_DATA. If PRIO_DATA=PRIO_1, this means that no other higher priority concurrent task has been initiated between times t1 and t2. In this case, the value x2 of the variable VAR may be copied to the memory. However, this is not the case in FIG. 6, where TASK_2 of higher priority PRIO_2 has been initiated at a time t3 between t1 and t2. Thus, at time t2, PRIO_DATA is no longer PRIO_1, and hence the value x2 of the variable VAR is not copied to the memory and remains in the buffer BUFF_2.

In the case of FIG. 6, at time t2, PRIO_DATA has the value of PRIO_INI (i.e. it is equal to 0) because at time t2 TASK_2 has already completed (at t4 between t1 and t2). If TASK_2 had not already completed, PRIO_DATA would have the value PRIO_2, and the result as regards copying or not copying the variable x2 would be the same since at time t2, PRIO_DATA is still not PRIO_1.

Priority management from the point of view of TASK_2 is also managed via steps S1 and S2. Thus, in step S1, at time t3, the variable VAR has the value x and PRIO_DATA has the value PRIO_1. PRIO_DATA is compared to PRIO_2. As PRIO_2>PRIO_1, TASK_2 has priority over TASK_1 as regards managing the variable VAR and PRIO_DATA is updated with the value PRIO_2.

The value x of the variable VAR is copied to the buffer BUFF_2. The runnable RUN_21 of TASK_2 is initiated with the value x of the variable VAR copied to the buffer BUFF_2. When the runnable RUN_21 ends, it produces an updated value y of the variable VAR, which is copied to the buffer BUFF_2.

Priority management according to step S2 then occurs in order to determine whether the value y of the variable VAR may be copied to the memory in order to be used by other tasks. At time t4 (which is the time at which the buffer BUFF_2 is emptied), the priority PRIO_2 of TASK_2 is compared to PRIO_DATA. If PRIO_DATA=PRIO_2, this means that no other higher priority concurrent task has been initiated between times t3 and t4. In this case, the value y of the variable VAR may be copied to the memory. However, this is not the case in FIG. 6 where TASK_2 is the task of highest priority PRIO_2. Thus, at time t4, PRIO_DATA is still PRIO_2, and hence the value y of the variable VAR is copied to the memory, and PRIO_DATA is reset to PRIO_INI. This value will remain as it is even at the end of execution of TASK_1, which reflects the fact that TASK_2 has priority as regards the value of the variable VAR over TASK_1 when TASK_1 is temporally concurrent with TASK_2.

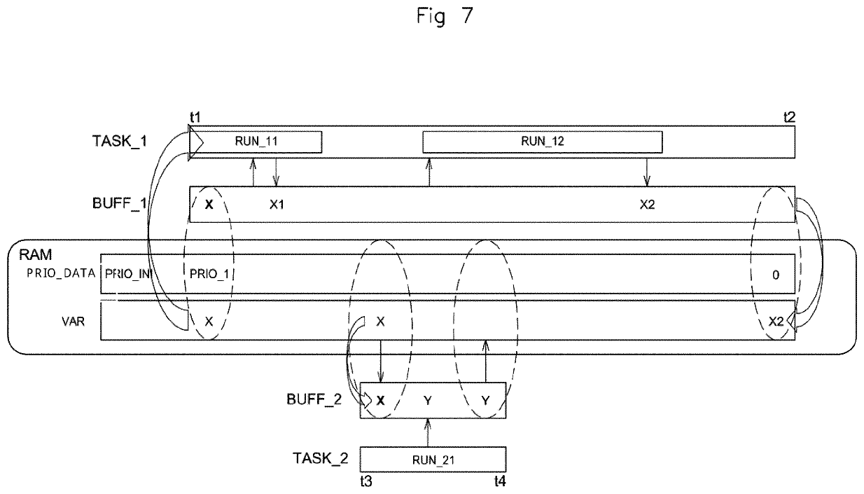

FIG. 7 shows a similar scenario to the one shown in FIG. 6, except that the priority PRIO_1 of TASK_1 is higher than the priority PRIO_2 of TASK_2.

Thus, in TASK_1, at time t1, the value x of the variable VAR is copied to the buffer BUFF_1. As regards PRIO_DATA, at time t1 PRIO_DATA=0, therefore PRIO_DATA<PRIO_1, and thus PRIO_DATA is updated with the value PRIO_1. At the time t2 at which execution of TASK_1 ends, PRIO_DATA is still equal to PRIO_1, since no other higher priority concurrent task has been initiated between times t1 and t2. Thus, PRIO_DATA is updated to PRIO_INI (i.e. set equal to 0), and the value x2 obtained at the end of the second runnable RUN_12 is copied to the memory to become the new value of the variable VAR.

As regards management of priority in TASK_2, at time t3, the value x of the variable VAR is copied to the buffer BUFF_2. As regards PRIO_DATA, at time t3 PRIO_DATA=PRIO_1, therefore PRIO_DATA>PRIO_2, and thus PRIO_DATA is not updated with the value PRIO_2. At the time t4 at which the buffer BUFF_2 of TASK_2 is emptied, PRIO_DATA is still equal to PRIO_1, and the value y obtained at the end of the second runnable RUN_21 is not copied to the memory to become the new value of the variable VAR.

The value of VAR at the end of execution of TASK_1 will be the value x2 of TASK_1, this clearly reflecting the fact that TASK_1 has priority as regards the value of the variable VAR over TASK_2 when TASK_2 is temporally concurrent with TASK_1.

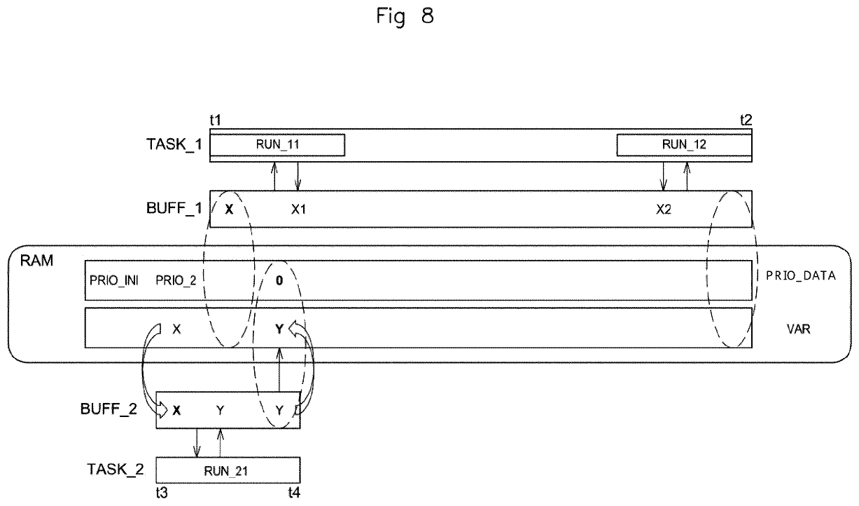

In the case of FIG. 8, the priority PRIO_2 of TASK_2 is higher than the priority PRIO_1 of TASK_1, as in the case of FIG. 6. In contrast, contrary to the case of FIG. 6, TASK_2 is initiated temporally before TASK_1. The management of priority is therefore achieved as follows, by applying steps S1 and S2:

As regards management of priority in TASK_1, at time t1, which is after t3, the value x of the variable VAR is copied to the buffer BUFF_1. The value of the variable VAR has not been modified at that time by TASK_2 since the latter has not yet ended at time t1.

As regards PRIO_DATA, at time t1 PRIO_DATA=PRIO_2. As PRIO_1<PRIO_DATA, PRIO_DATA is not updated with the value PRIO_1, because TASK_1 does not have priority over TASK_2. At the time t2 at which the buffer BUFF_1 of TASK_1 is emptied, PRIO_DATA=0 (as TASK_2 has ended and reset the variable PRIO_DATA), and the value x2 obtained at the end of the second runnable RUN_12 is not copied to the memory to become the new value of the variable VAR.

As regards management of priority in TASK_2, at time t3, the value x of the variable VAR is copied to the buffer BUFF_2. As regards PRIO_DATA, at time t3 PRIO_DATA=PRIO_INI (=0), therefore PRIO_DATA<PRIO_2, and thus PRIO_DATA is updated with the value PRIO_2. At the time t4 at which the buffer BUFF_2 of TASK_2 is emptied, PRIO_DATA is still equal to PRIO_2, and the value y obtained at the end of the second runnable RUN_21 is copied to the memory to become the new value of the variable VAR, and PRIO_DATA is reset to PRIO_INI.

This value will remain as it is even at the end of execution of TASK_1, which reflects the fact that TASK_2 has priority as regards the value of the variable VAR over TASK_1 when TASK_1 is temporally concurrent with TASK_2.

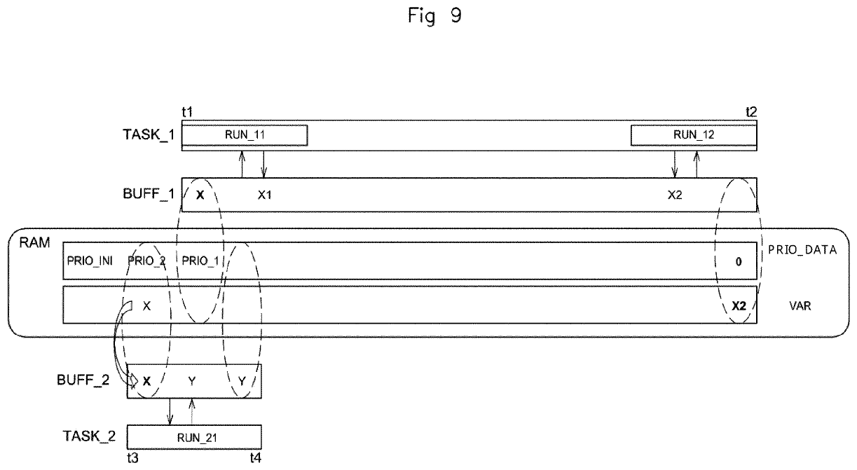

The case in FIG. 9 is a similar scenario to the one shown in FIG. 8, except that the priority PRIO_1 of TASK_1 is higher than the priority PRIO_2 of TASK_2. The management of priority is therefore achieved as follows, by applying steps S1 and S2:

As regards management of priority in TASK_1, at time t1, which is after t3, the value x of the variable VAR is copied to the buffer BUFF_1. As regards PRIO_DATA, at time t1 PRIO_DATA=PRIO_2. As PRIO_1>PRIO_DATA, PRIO_DATA is updated with the value PRIO_1, because TASK_1 has priority over TASK_2. At the time t2 at which the buffer BUFF_1 of TASK_1 is emptied, PRIO_DATA still has the value of PRIO_1. The value x2 obtained at the end of the second runnable RUN_12 is therefore copied to the memory to become the new value of the variable VAR, and PRIO_DATA is reset to PRIO_INI.

As regards management of priority in TASK_2, at time t3, the value x of the variable VAR is copied to the buffer BUFF_2. As regards PRIO_DATA, at time t3 PRIO_DATA=PRIO_INI (=0), therefore PRIO_DATA<PRIO_2, and thus PRIO_DATA is updated at t3 with the value PRIO_2. At the time t4 at which the buffer BUFF_2 of TASK_2 is emptied, PRIO_DATA has been updated to PRIO_1 at t1 because TASK_1 has priority over TASK_2. As at t4, PRIO_DATA is not PRIO_2, the value y of the variable VAR obtained at the end of the second runnable RUN_21 is not copied to the memory when the buffer BUFF_2 is emptied, to become the new value of the variable VAR.

The value of VAR at the end of execution of TASK_1 and TASK_2 is the value at the end of execution of TASK_1, this clearly reflecting the fact that TASK_1 has priority as regards the value of the variable VAR over TASK_2 when TASK_1 is temporally concurrent with TASK_2.

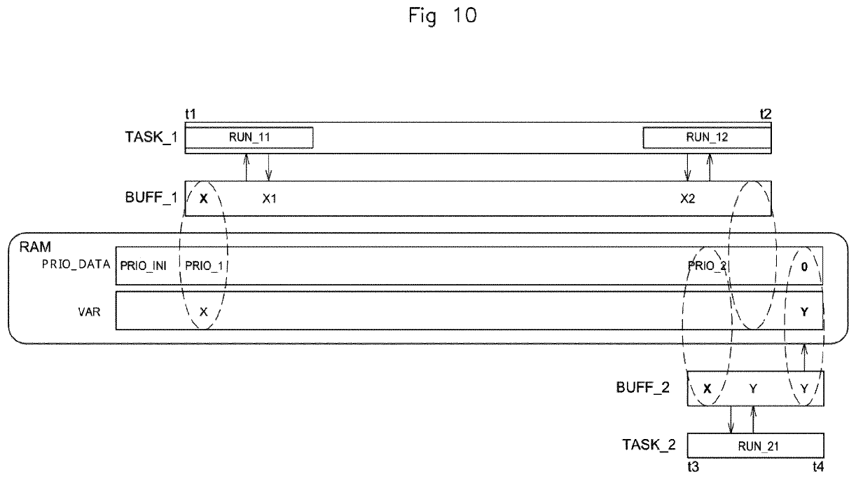

In the case of FIG. 10, the priority PRIO_2 of TASK_2 is higher than the priority PRIO_1 of TASK_1, and TASK_2 begins temporally after TASK_1, as in the case of FIG. 6. In contrast, contrary to the case of FIG. 6, TASK_2 ends temporally after TASK_1 at the buffer level. The management of priority is therefore achieved as follows, by applying steps S1 and S2:

As regards management of priority in TASK_1, at time t1, the value x of the variable VAR is copied to the buffer BUFF_1. As regards PRIO_DATA, at time t1 PRIO_DATA=PRIO_INI (=0). Since PRIO_1>PRIO_DATA, PRIO_DATA is updated with the value PRIO_1. At the time t2 at which the buffer BUFF_1 of TASK_1 is emptied, PRIO_DATA=PRIO_2 (as TASK_2 is initiated after TASK_1 and has priority over TASK_1), and the value x2 obtained at the end of the second runnable RUN_12 is not copied to the memory to become the new value of the variable VAR.

As regards management of priority in TASK_2, at time t3, which is after t1 and before t2, i.e. the time at which the buffer BUFF_2 of TASK_2 is filled, the value x of the variable VAR is copied to the buffer BUFF_2. As regards PRIO_DATA, at time t3 PRIO_DATA=PRIO_1, therefore PRIO_DATA<PRIO_2, and thus PRIO_DATA is updated with the value PRIO_2, since TASK_2 is initiated after TASK_1. At the time t4 at which the buffer BUFF_2 of TASK_2 is emptied, PRIO_DATA is still equal to PRIO_2, and the value y obtained at the end of the second runnable RUN_21 is copied to the memory to become the new value of the variable VAR, and PRIO_DATA is reset to PRIO_INI (in the case here 0).

Thus, the value of the variable VAR at the end of execution of TASK_1 and TASK_2 is the value of the variable VAR at the end of execution of TASK_2, this clearly reflecting the fact that TASK_2 has priority as regards the value of the variable VAR over TASK_1 when TASK_1 is temporally concurrent with TASK_2.

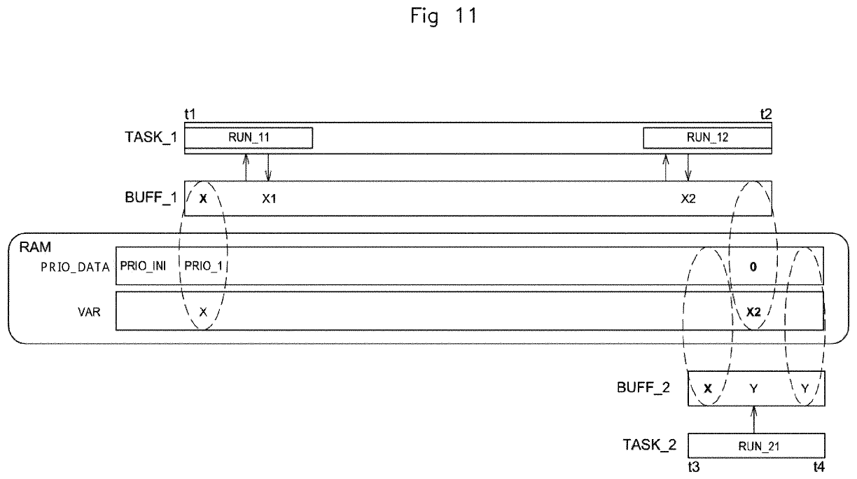

The case in FIG. 11 is a similar scenario to the one shown in FIG. 10, except that the priority PRIO_1 of TASK_1 is higher than the priority PRIO_2 of TASK_2. The management of priority is therefore achieved as follows, by applying steps S1 and S2:

As regards management of priority in TASK_1, at time t1, the value x of the variable VAR is copied to the buffer BUFF_1. As regards PRIO_DATA, at time t1 PRIO_DATA=PRIO_INI=0. Since PRIO_1>PRIO_DATA, PRIO_DATA is updated with the value PRIO_1. At the time t2 at which the buffer BUFF_1 is emptied (after execution of TASK_1), PRIO_DATA still has the value of PRIO_1, because even if TASK_2 was initiated at t3 between t1 and t2, its priority is lower, and PRIO_DATA has not been updated. The value x2 obtained at the end of the second runnable RUN_12 is copied at t4 to the memory to become the new value of the variable VAR, and PRIO_DATA is reset to PRIO_INI.

As regards management of priority in TASK_2, at time t3, the value x of the variable VAR is copied to the buffer BUFF_2. As regards PRIO_DATA, at time t3 PRIO_DATA=PRIO_1, therefore PRIO_DATA>PRIO_2 because TASK_1 has priority over TASK_2, and thus PRIO_DATA is not updated at t3 with the value PRIO_2. At the time t4 at which the buffer BUFF_2 is emptied (after execution of TASK_2), PRIO_DATA has been updated to PRIO_INI=0 at t2. As at t4, PRIO_DATA is not PRIO_2, the value y of the variable VAR obtained at the end of the second runnable RUN_21 of TASK_2 is not copied to the memory to become the new value of the variable VAR.

The value of VAR at the end of execution of TASK_1 and TASK_2 is the value at the end of execution of TASK_1, this clearly reflecting the fact that TASK_1 has priority as regards the value of the variable VAR over TASK_2 when TASK_1 is temporally concurrent with TASK_2.

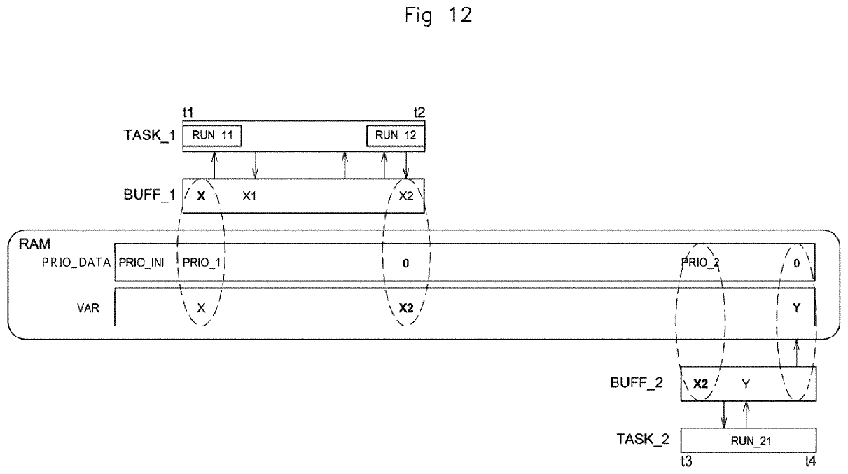

For illustration purposes, FIG. 12 shows a case where there is no temporal concurrence between TASK_1 and TASK_2, and where TASK_1 is performed temporally before TASK_2. Regardless of the priorities of TASK_1 and TASK_2 relative to each other, the value of the variable VAR at the end of execution of TASK_1 and TASK_2 is the value of the variable VAR at the end of execution of TASK_2, because TASK_2 is initiated temporally after execution of TASK_1. When each non-concurrent task TASK_1 or TASK_2 starts, the value of PRIO_DATA in memory being equal to PRIO_INI, each task has priority in assigning the variable VAR.

1. A computer-implemented method for managing data shared through a memory, wherein a shared variable VAR is stored in the memory, the variable VAR being accessible by at least two tasks TASK_i (i=1 . . . n, n>2) executed in parallel with one another, each task TASK_i comprising at least one runnable RUN_ij (j=1 . . . k, k≥1), when TASK_i comprises at least two runnables RUN_ij the latter are executed sequentially, a priority variable PRIO_DATA associated with the variable VAR being stored in the memory and initially taking a value PRIO_INI, a priority constant PRIO_i being stored in the memory for each of the tasks TASK_i, the priority constant PRIO_i characterizing the priority order of the task TASK_i, PRIO_INI being reserved for the lowest priority and being different from each of the priority constants PRIO_i, each of the runnables RUN_ij having an associated priority constant PRIO_RUN_ij characterizing the priority order of the runnable RUN_ij producing the variable VAR, for each of the tasks TASK_i, the priority constant PRIO_i of the task TASK_i being the maximum of the priority constants PRIO_RUN_ij of the runnables RUN_ij of this task, the method comprising the following steps:
at a time t1:
initiating the i-th task TASK_i using the value of the variable VAR shared at t1 in the memory, and
if PRIO_i>PRIO_DATA at time t1 then PRIO_DATA is updated to the value PRIO_i,
after execution of the same i-th task TASK_i at a time t2>t1, the i-th task TASK_i generates a value VAR_UPDATE_i of the variable VAR,
if PRIO_DATA at time t2=PRIO_i, then VAR is updated to the value VAR_UPDATE_i and PRIO_DATA is updated to the value PRIO_INI.

2. The method for managing shared data as claimed in claim 1, wherein the values of each PRIO_i are strictly increasing in the priority order of the task TASK_i producing the variable VAR, PRIO_INI being smaller than each of the priority constants PRIO_i, and preferably PRIO_INI=0.

3. The method for managing shared data as claimed in claim 1, wherein each of the tasks TASK_i is executed on a CORE_i of its own.

4. The method for managing shared data as claimed in claim 1, in addition comprising a first buffer BUFF_1 arranged between the memory and a first core CORE_1 on which a first task TASK_1 is executed, and/or a second buffer BUFF_2 arranged between the memory and a second core CORE_2 on which a second task TASK_2 is executed, the first and second buffers BUFF_1, BUFF_2 comprising copies of the values of the variables VAR used by TASK_1 and TASK_2 as input and output of TASK_1 and TASK_2, the first and second buffers BUFF_1, BUFF_2 being able to interact with the memory to modify the variable VAR output from the tasks TASK_i.

5. The method for managing shared data as claimed in claim 4, wherein the first and second buffers BUFF_1, BUFF_2 comprise copies of the values of the variables VAR input into and output from the runnables RUN_1j, RUN_2j of each of TASK_1 and TASK_2.

6. The method for managing shared data as claimed in claim 1, wherein the priority constant PRIO_i is created offline.

7. A computer program, comprising instructions for implementing at least part of the method as claimed in claim 1 when the software is executed by a processor.

8. A computing device comprising:
a memory for storing instructions for implementing at least part of the method as claimed in claim 1 when the software is executed by a processor,
a processor that accesses the memory to read the aforementioned instructions and then execute the method.

9. A non-transient computer-readable storage medium on which a computer program for implementing the method as claimed in claim 1, when the computer program is executed by a processor, is stored.

10. A vehicle with an embedded system comprising the computing device of claim 8.
